(19) United States
(12) Patent Application Publication
(10) Pub. No.: US 2011/0297311 A1
(43) Pub. Date: Dec. 8, 2011

(54) FILM FOR THE LAMINATION OF GRAPHIC MEDIA AND PRODUCTION METHOD THEREOF

(75) Inventors: Javier DEL BARRIO PÉREZ, Jaen (ES); Manuel LÓPEZ QUESADA, Jaen (ES)

(73) Assignee: DERPROSA FILM, S.L.

(21) Appl. No.: 13/212,266

(22) Filed: Aug. 18, 2011

Related U.S. Application Data
(63) Continuation-in-part of application No. PCT/ES2009/070282, filed on Jul. 10, 2009.

(30) Foreign Application Priority Data
Feb. 19, 2009 (ES) P200900469

(51) Int. Cl. B32B 27/08; B32B 27/40; C09J 175/04; B32B 7/02; B31B 1/62; B32B 38/10

(52) U.S. Cl. 156/272.6; 156/60; 156/331.7; 428/216

(57) ABSTRACT

The invention relates to a film for the lamination of graphic media, comprising an extruded plastic film core or substrate (I) which is coated with a liquid based dispersion of aliphatic polyurethane (2) having a milky white appearance, which dispersion can contain other chemical products such as other plastic resins (binders), hardening agents (crosslinkers) and/or adhesives (primers) in order to obtain the desired degree of hardness, adhesion and soft touch.

### CROSS-REFERENCE TO RELATED APPLICATIONS

This application is a continuation-in-part of PCT Application ES2009/070282 filed on Jul. 10, 2009, which claimed the benefit of Spanish Patent Application No. P200900469 filed 19 Feb. 2009, the contents of which are incorporated herein by reference.

### OBJECT OF THE INVENTION

The instant invention discloses a new film having a matte finish for lamination of graphic supports which provides several competitive advantages with respect of the films traditionally applied in this sector.

The application of this product is the market of lamination, among these, lamination of book covers, cartons, boxes, bags, posters, impermeable corrugated cardboard, gift wrapping paper, catalogues, printing jobs and printed matter in general.

### BACKGROUND OF THE INVENTION

The lamination of graphic supports for matte finishes is currently made employing films that are manufactured by the coextrusion method, in which the matte face is shaped by means of a coextrusion by the incorporation of a polyolefin that is incompatible with the substrate base. Coextrusion is the simultaneous extrusion through a die of two or more polyolefins to form a multi-layered structure. Whether dealing with the procedure of blown films, cast films, laminas or profiles, the coextrusion system needs to distribute the coextruded output guaranteeing a uniform distribution of its thickness, minimizing the distortions in the interface between the different levels and foreseeing problems of interfacial instability.

Coextrusion enables the combination of polymers that possess different properties so as to ensure a more economical and functional packing. However, current matte films manufactured by extrusion and employed in the lamination of supports display certain deficiencies such as, for example, a relatively low resistance to scratching and a certain tendency to deteriorate or skew the tonalities of the colors of the graphic support.

### DESCRIPTION OF THE INVENTION

The film object of the invention is configured by a substrate or nucleus of plastic film of bi-oriented polypropylene manufactured by extrusion with thicknesses comprising between 5 and 150 μm, and preferably between 10 and 40 μm. To this is added by coating a water-based aliphatic polyurethane dispersion having a milky white appearance of the type Neorez R-1010 of DMS Neoresins. This coating, when dry, has a thickness comprised of between 0.2 and 5 μm and preferably between 1 and 3 μm, and contains between 30% and 100% solids of polyurethane depending on the degree of soft touch required, and preferably between 70% and 95%. The dispersion can be applied over the polypropylene surface by any means known by the skilled person, such as a gravure anilox roll and a doctor blade coating system. The thinner of the dispersion is preferably evaporated by drying in a continuous oven, resulting in a coating having excellent clarity by contact, extra-matte finish and peach skin effect.

Said dispersion of aliphatic polyurethane can incorporate in its composition also a specific primer for plastic laminas, preferably a urethane aliphatic dispersion which has as its purpose to improve the adherence of the plastic substrate and/or hardness of the film for lamination.

Furthermore, the aliphatic polyurethane dispersion can also incorporate into its composition a hardener of a type of polymer chains with crosslinkers suitable for polyurethanes of the type acridine or isocianate which includes between 0.5 to 15% solids with respect to the polyurethane base, and/or other plastic resins that act as binders, comprising between 0 and 70% in weight, and which function as a base and support of the polyurethane resin and make it possible to obtain desired degree of soft touch and matte.

The film obtained in this way can be a dry finish, in which case a self-adhesive laminated resin is used on the non-matte face, that could be polyethylene (PE), ethyl vinyl acetate (EVA), ethylene butyl acrylate (EBA), ethylene methyl acrylate (EMA) and/or ethylene ethyl acrylate (EEA). These enable the adhesion to the graphic support by means of heat application. The film can also be manufactured with a wet finish, in which case no self-adhesive resin whatsoever is applied on the non-matte face, rather the surface of said face is modified by a corona or chemical treatment, and thus is prepared for the application of adhesives and glues during the lamination process.

This kind of matte film for lamination of graphic support is manufactured by extrusion of one substrate or nucleus of plastic film, to which is added a liquid dispersion coating of aliphatic polyurethane base having a milky white appearance. Besides surmounting the drawbacks of traditional films, this kind of film provides other important features and improvements that make it unique and significantly distinguishable from the rest of matte films that currently exist in the market. The main advantages and differentiating features of this film, especially in reference to its matte face, are the following:
Good anti-scratch effects.
A soft touch, that is to say, a very enjoyable peach skin effect to the touch, and the elimination of the “plastic” effect of traditional films.
Depending on the percentage of polyurethane applied in the mixture, a shine value of less than 5%, measured at 60° (ASTM 02457-90) can be obtained. The result of this value is that it results practically in a complete lack of reflection in comparison with traditional matte films manufactured by extrusion, the shine range of which is between 8% and 12%.
A high transparency by contact. There is practically no loss of tonality of the graphic support. Traditional matte films produce a whitish film on account of the type of matting agent that causes a loss of tonality of the colors it covers.

### DESCRIPTION OF THE DRAWINGS

To complete the description that is being provided and for the purpose of facilitating the understanding of the features of the invention, the instant document is accompanied by a set of figures in which, for illustrative purposes and not limiting, the following is depicted:

FIG. 1 shows a transversal section of a film for the lamination of graphic supports, provided with a dry finish.

FIG. 2 shows a transversal section of a film for the lamination of graphic supports, provided with a wet finish.

### PREFERRED EMBODIMENT OF THE INVENTION

As can be seen in the referenced figures, the film for lamination of graphic supports comprises a substrate or nucleus of plastic film (1) manufactured by extrusion thicknesses comprising between 5 and 150 μm, to which is added by coating a liquid dispersion of aliphatic polyurethane base (2) having a milky white appearance, which could contain other chemical products such as other plastic resins (binders), hardeners (crosslinkers) and/or adhesives (primers) for the purpose of obtaining the desired degree of hardness, adherence and soft touch.

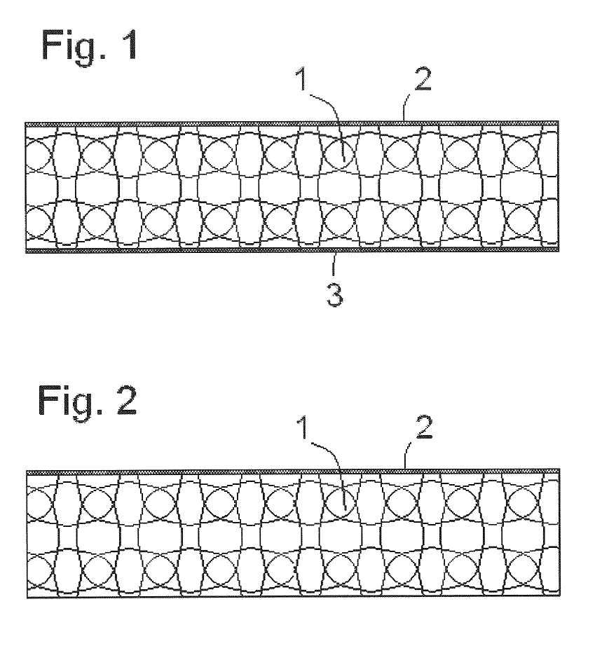

As can be seen in FIG. 1, a self-adhesive resin (3) has been applied to the non-matte face. This adhesive resin could be polyethylene (PE), ethyl vinyl acetate (EVA), ethylene butyl acrylate (EBA), ethylene methyl acrylate (EMA) and/or ethylene ethyl acrylate (EEA), that is attached to the support by means of adhesion and heat application, thus providing it a dry finish.

FIG. 2 shows a film with a wet finish, which is obtained by applying a corona or chemical treatment to the non-matte face, leaving it prepared for the application of adhesives and glues, without applying in this case any self-adhesive resin whatsoever on the surface of said face.

Having sufficiently described the nature of the invention, as well as an example of the preferred embodiment, it is hereby stated for the appropriate purposes, that the materials, shape, size and disposition of the described elements could be modified, as long as any modification does not imply an alteration of the essential features of the invention, which are claimed as follows:

1. A film for the lamination of graphic supports comprising a substrate or nucleus of plastic film (1) of bi-oriented polypropylene manufactured by extrusion with a thickness comprised of between 5 and 150 μm, and preferably between 10 and 40 μm, to which is added by coating a water-based aliphatic polyurethane dispersion having a milky white appearance (2) characterized in that the coating, when dry, has a thickness comprised of between 0.2 and 5 μm and preferably between 1 and 3 μm, and contains between 30% and 100% solids of polyurethane solids and preferably between 70% and 95%, depending on the degree of soft touch required.

2. A film for the lamination of graphic supports in accordance with claim 1, wherein the dispersion of aliphatic polyurethane incorporates in its composition a specific primer for plastic laminas for improving the adherence to the plastic substrate and/or the hardness of the film for lamination.

3. A film for the lamination of graphic supports in accordance with claim 1 wherein, besides the aliphatic polyurethane, the dispersion of aliphatic polyurethane incorporates into its composition a hardener of a type of polymer chains with crosslinkers and/or other plastic resins that act as binders, comprising between 0 and 70% in weight, and which function as a base and support of the polyurethane resin and make it possible to obtain desired degree of soft touch and matte.

4. A film for the lamination of graphic supports in accordance with claim 1 wherein it presents a dry finish that is obtained by the application of a self-adhesive laminated resin (3) on the non-matte face, based on polyethylene (PE), ethyl vinyl acetate (EVA), ethylene butyl acrylate (EBA), ethylene methyl acrylate (EMA) and/or ethylene ethyl acrylate (EEA), that is attached to the graphic support by means of adhesion by heat application.

5. A film for the lamination of graphic supports in accordance with claim 1, wherein it presents a wet finish that is obtained by the application on the non-matte face a corona or chemical treatment, leaving said face prepared for the application of adhesives and glues, without applying in this case any self-adhesive resin whatsoever on the surface of said face.

6. A film for the lamination of graphic supports in accordance with claim 1, wherein the dispersion is a water-based aliphatic polyurethane dispersion of the type Neorez R-1010 of DSM Neoresins.

7. A use of a film comprising a substrate or nucleus of plastic film (1) manufactured by extrusion with thicknesses comprising between 5 and 150 μm to which is added by coating a liquid base dispersion of aliphatic polyurethane having a milky white appearance (2), wherein the coating, when dry, has a thickness of between 0.2 and 5 μm and contains between 30% and 100% solids of polyurethane solids, depending on the degree of soft touch required, in the lamination of graphic supports.

8. The use of a film according to claim 7, wherein the thickness of the substrate or nucleus of plastic film (1) is comprised between 10 and 40 μm.

9. The use of a film according to claim 7, wherein the thickness of the coating, when dry, is comprised between 1 and 3 μm.

10. The use of a film according to claim 7, wherein the content of polyurethane solids in the dry coating is between 70% and 95%, depending on the degree of soft touch required.

11. The use of a film according to claim 7, wherein the liquid base dispersion further comprises an adhesive (primer) specific for plastic laminas, for improving the adherence to the plastic substrate and/or the hardness of the film for lamination.

12. The use according to claim 11, wherein the adhesive is a urethane aliphatic dispersion.

13. The use of a film according to claim 7, wherein the liquid base dispersion further comprises a hardener of a type of polymer chains with crosslinkers and/or other plastic resins acting as binders, comprising between 0 and 70% in weight, and which function as a base and support of the polyurethane resin and make it possible to obtain desired degree of soft touch and matte.

14. The use of a film according to claim 7, wherein a self-adhesive resin (3) based on polyethylene (PE), ethyl vinyl acetate (EVA), ethylene butyl acrylate (EBA), ethylene methyl acrylate (EMA) and/or ethylene ethyl acrylate (EEA) is applied on the face of the film opposed to the coating, for its attachment to the graphic support by means of adhesion by heat application in such a manner that a dry finish is obtained.

15. The use of a film according to claim 7, wherein a corona or chemical treatment is applied on the face of the film opposed to the coating, leaving said face prepared for the application of adhesives and glues for its attachment to the graphic support in such a manner that a wet finish is obtained.
